(19) United States
(12) Patent Application Publication
(10) Pub. No.: US 2023/0150077 A1
(43) Pub. Date: May 18, 2023

(54) Log Cutting Saw With Automatic Blade Changer and Method of Using Same

(71) Applicant: Paper Converting Machine Company, Green Bay, WI (US)

(72) Inventors: Jonathon T. Zahn, Green Bay, WI (US); Cory L. Schubring, De Pere, WI (US)

(21) Appl. No.: 17/958,606

(22) Filed: Oct. 3, 2022

Related U.S. Application Data
(60) Provisional application No. 63/280,872, filed on Nov. 18, 2021.

(51) Int. Cl. B23Q 3/155

(52) U.S. Cl. CPC B23Q 3/1554; B23Q 3/15553; B23Q 2003/155404

(57) ABSTRACT

A tissue log cutting saw has an arm movable orbitally within an interior of saw house. A spindle and housing is mounted to the arm. A tool holder with a blade is arrangeable at a first end of the spindle, and an opposite second end rotationally drives the spindle while providing access to an operator of a clamp in the spindle. The clamp is moveable between a hold position in which the clamp engages the tool holder at the first end, and a release position in which the clamp disengages from the tool holder and allows the tool holder to be removed from the first end. An actuator mounted to a structure separate from the arm has an end effector that cooperates with the operator of the clamp to enable the tool holder to be released from the clamp to facilitate automatic changing of a blade of the saw.

The present application claims priority benefit of U.S. provisional application Ser. No. 63/280872, filed Nov. 18, 2021, the disclosure of which is incorporated by reference herein.

### SUMMARY

The present disclosure is directed to a log cutting saw, for instance, a tissue log cutting saw. The log cutting saw is adapted and configured to cut logs axially into rolls for consumer use. The log cutting saw may include a saw house. Within an interior of the saw house, the saw may be provided with an arm that orbitally moves while a saw blade rotates for cutting one or more tissue logs introduced into the saw house. The logs may be conveyed on a conveyor that moves through the interior of the saw house. The saw may include an arm with one or more blades for cutting the logs in the interior of the saw house.

### DESCRIPTION OF THE DRAWINGS

FIG. 1 is a perspective view of a saw including a saw house and a blade array storage unit mounted on a slide of the saw house.

FIG. 2 is a top partial view of an interior of the saw house showing a tool change actuator mounted to a structure of the saw and a spindle assembly mounted on an arm of the saw.

FIG. 3 is a partial perspective view of the interior of the saw house showing the arm and the spindle assembly and the tool change actuator.

FIG. 4 is another partial perspective view of the interior of the saw house showing the arm and the spindle assembly and the tool change actuator.

FIG. 5 is a perspective view of the tool change actuator.

FIG. 6 is a top view of the tool change actuator.

FIG. 7 is a side view of the tool change actuator.

FIG. 8 is a perspective view of the arm and spindle assembly.

FIG. 9 is a top view of the arm and spindle assembly.

FIG. 10A is a front view of the arm and spindle assembly.

FIG. 10B is another front view of the arm and spindle assembly with a blade grinding unit and a blade guard assembly covering a saw blade;

FIG. 10C is a view of the blade grinding unit of FIG. 10B.

FIG. 11 is a cross-sectional side view of the spindle assembly taken along lines 11-11 of FIG. 10A.

FIG. 12 is a cross-sectional side view of the spindle assembly of FIG. 11 with a tool holder of the saw blade removed from the end of the spindle.

FIG. 13 is a cross-sectional side view of the spindle.

FIG. 14 is a perspective view of a blade array.

FIG. 15 is another perspective view of the blade array.

FIG. 16 is a side view of the blade array with a storage unit of the blade array in the extended position.

FIG. 17 is cross-sectional front view of the blade array taken along lines 17-17 of FIG. 16.

FIG. 18 is a representation of the orientation of the saw blades stored coaxially aligned in the blade array.

FIG. 19 is a front view of a saw blade mounted on a tool holder.

FIG. 20 is a rear view of the saw blade mounted on the tool holder.

FIG. 21 is a front view of the tool holder.

FIG. 22 is a rear view of the tool holder.

### DESCRIPTION

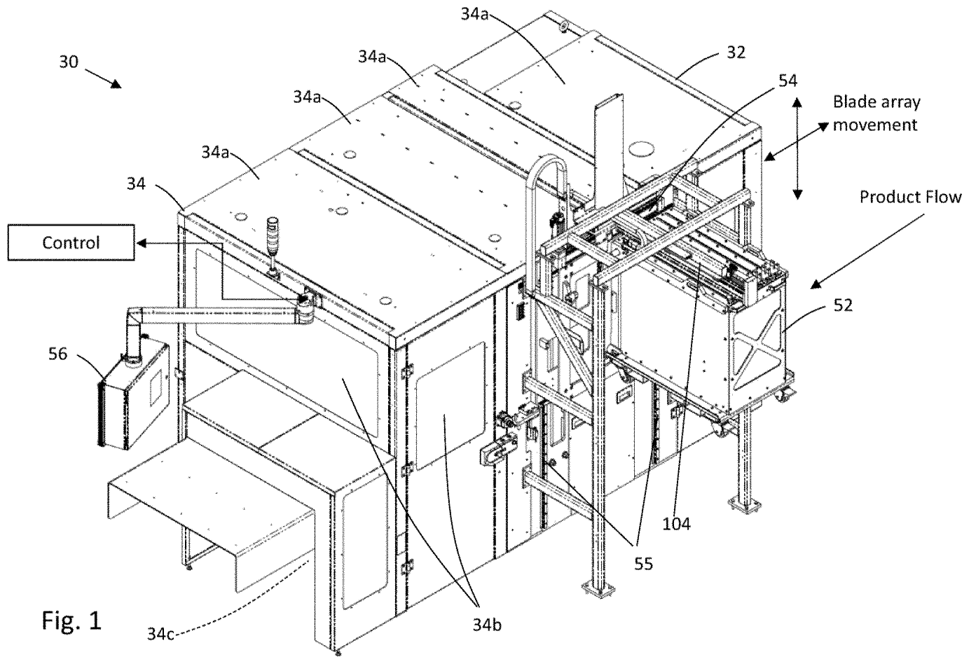

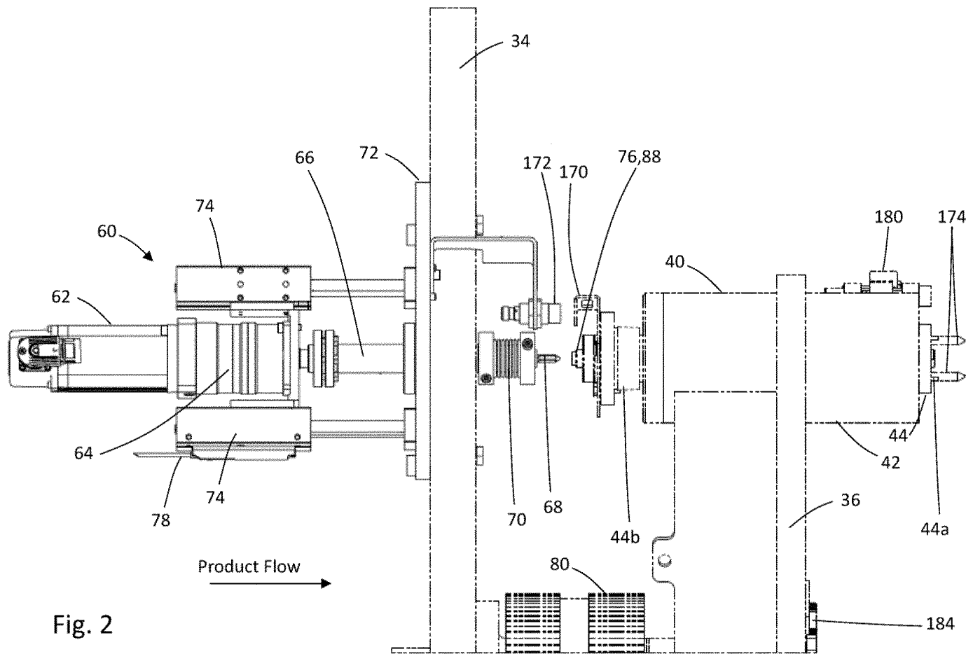

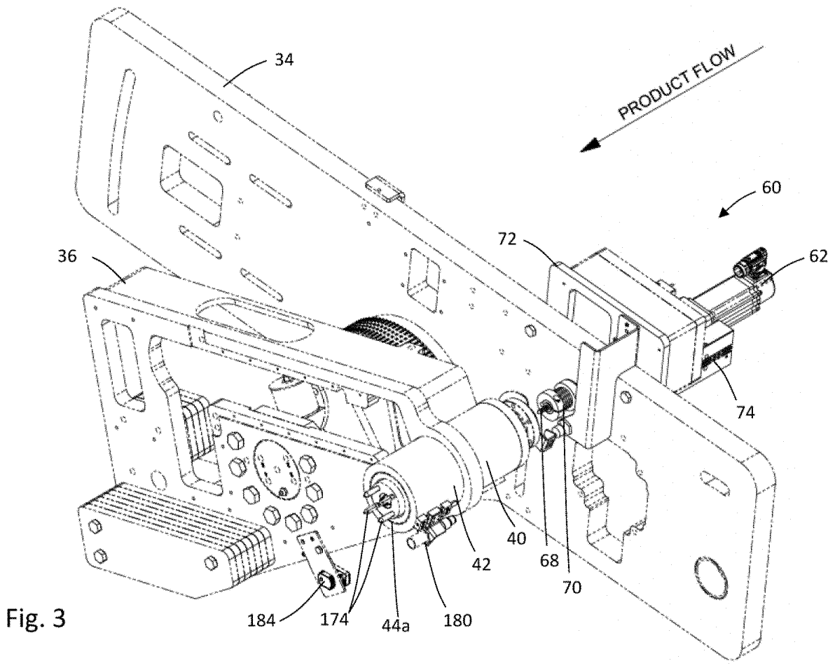

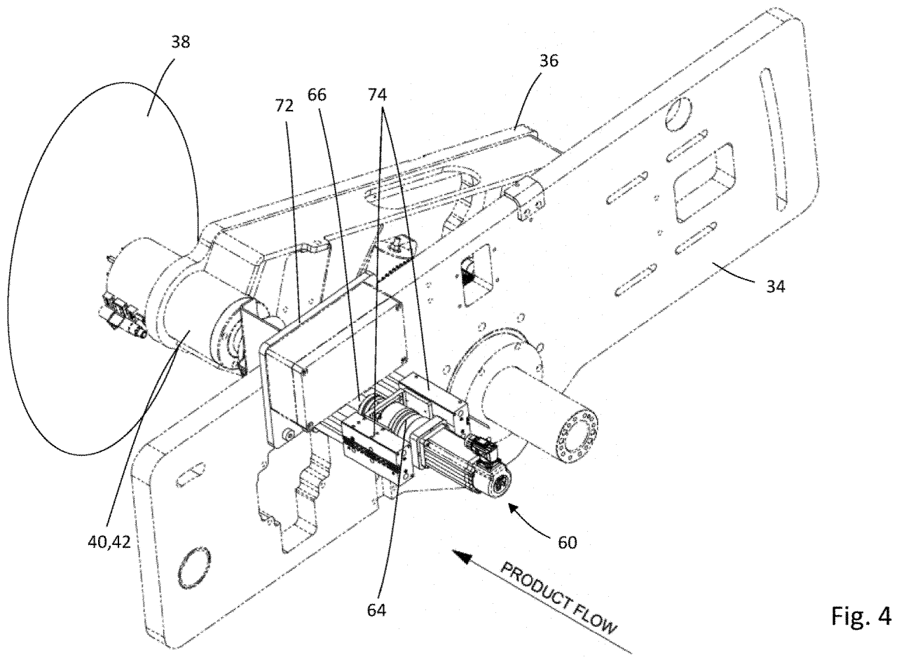

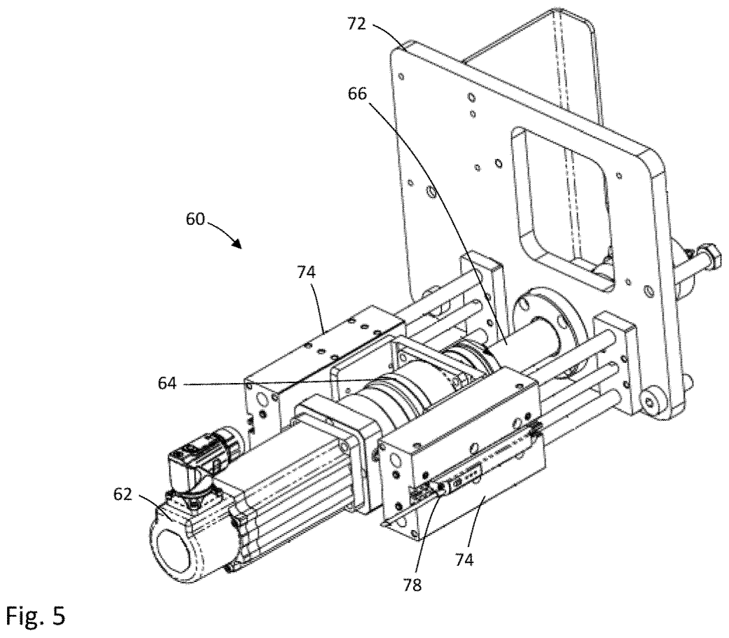

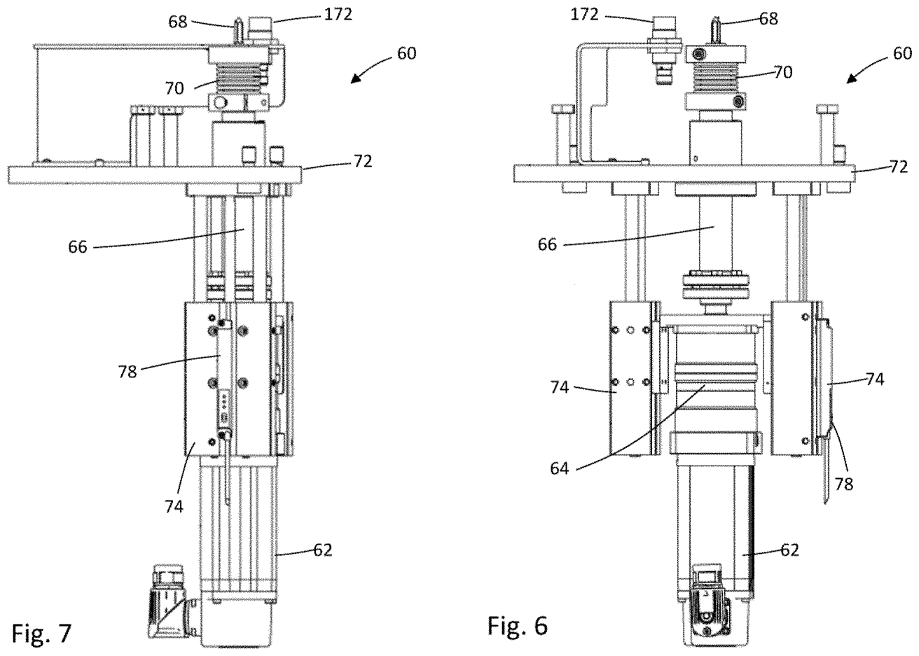

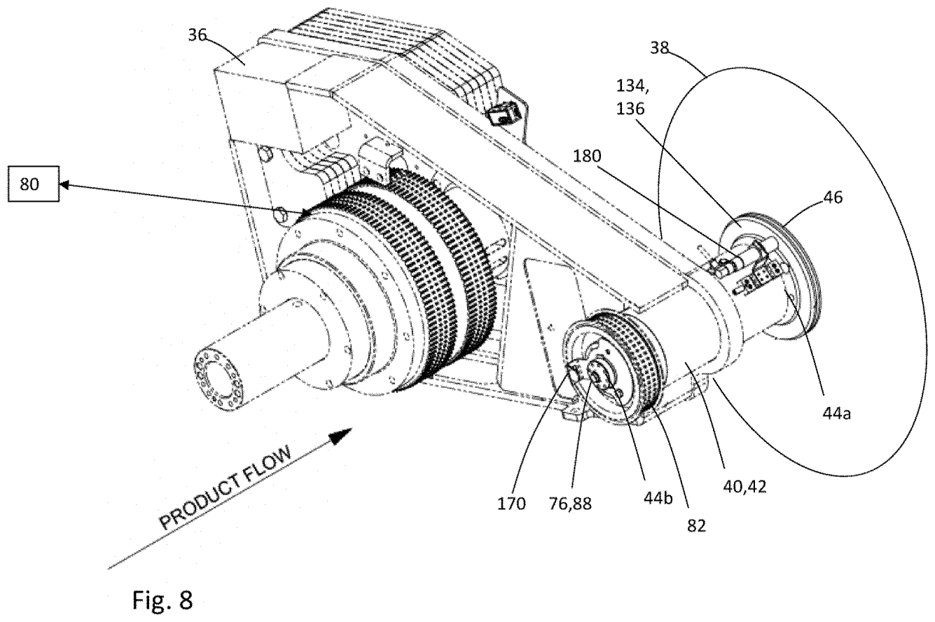

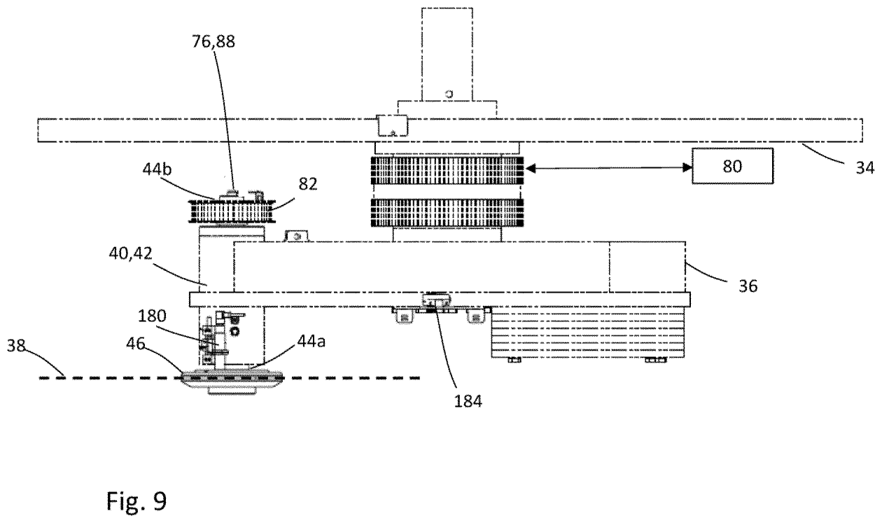

FIG. 1 shows an exemplary saw 30 and saw house 32. The saw house 32 comprises a rectangular structure with a support frame 34, panels 34a and a viewing window(s) 34b. Typically, the material to be cut in the saw house, for instance, logs of convolutely wound web material are passed through an interior 34c of the saw house 32 on a conveyor with an arm 36 of the saw 30 moving orbitally as one or more saw blades 38 rotate and cut the logs into rolls for consumer end use within the interior of the saw house. The conveyor may be in accordance with U.S. Pat. No. 10,272,585, the disclosure of which is incorporated by reference. The logs may be held during cutting by clamps in accordance with pending U.S. Pat. No. 11,447,362, the disclosure of which is incorporated by reference. The arm 36 may include a spindle assembly 40 mounted on the arm.

The spindle assembly 40 may include a spindle housing 42 and a spindle 44 rotatably disposed in the housing. The spindle 44 may be adapted and configured to rotate one or more saw blades 38, each of which may be mounted to the spindle 44 in a tool holder 46 at an end of the spindle. Multiple conveyor lanes may be provided through the interior of the saw house 32 to cut the logs as the logs are advanced to the saw blade 38. One or more spindle assemblies 40 may be mounted on the arm, each with the functionality described below. Thus, multiple saw blades 38 may be disposed on the arm, although not shown in the drawings. A blade guard assembly 48 in accordance with U.S. Pat. No. 11,305,394, the disclosure of which is incorporated by reference, may be provided.

The exemplary saw 30 further includes a storage unit 50 that is adapted and configured to store the saw blade 38 mounted on the tool holder 46. Accordingly, the saw 30 is adapted and configured to exchange the saw blade 38 between the spindle 40 and the storage unit 50. In one aspect, the storage unit 50 is adapted and configured to move between an extended position in which the storage unit is disposed in the interior 34c of the saw house 32 adjacent the spindle 44 and a retracted position in which the storage unit 50 is moved away from the spindle, which may be within the interior of the saw house or to a location exterior to the saw house. In another example, the storage unit may be withdrawn from the interior 34c of the saw house 32 in the retracted position. In another example, the storage unit 50 may be detachably connected to the structure 34 of the saw house. In another example, the storage unit 50 may be provided as one of a plurality of like storage units as a blade array or storage system 52. In another example, the blade array or storage system 52 may be in accordance with U.S. Pat. No. 10,946,546, the disclosure of which is incorporated by reference herein. In another example, the blade array or storage system 52 may be movable in the direction of the log travel relative to the structure 34 of the saw 30 so that each storage unit 50 in the blade array may be positioned adjacent the spindle 44 to allow exchange of the saw blade 38 between the spindle and the respective storage unit. For instance, each storage unit may be configured in the blade array to store a saw blade 38 such that the center axes of rotation of the saw blades in the blade array is aligned coaxially. The blade array 52 may be mounted to a horizontal slide 54 on the structure 34 of the saw house 32 that moves the blade array in a direction parallel to the center axis of rotation of the saw blade and parallel to the direction of log advancement through the saw house. Accordingly, the slide 54 may position the blade array 52 such that each storage unit 50 of the blade array may be moved in a direction parallel to the direction of advancement of the log, and then perpendicular to the direction of advancement of the log from the blade array into the interior of the saw house and adjacent the spindle 44 to allow exchange of the saw blade 38 between the spindle and the respective storage unit when the respective storage unit is in the extended position. A vertical slide 55 on the structure 34 of the saw house 32 may also be provided to allow for adjustment of the vertical position of the blade array 52 to facilitate exchange of the saw blade 38 between the spindle and the respective storage unit when the respective storage unit is in the extended position.

The saw 30 may have a human machine interface HMI 56 to allow an operator to control operation of the saw. The HMI 56 may have a control associated with the saw, the blade array 52, the storage unit 50, and/or the conveyor. The HMI 56 may allow the operator to enable the saw for cutting a log. When the saw 30 is enabled for cutting operations, the saw moves the arm 36 orbitally within the interior 34c of the saw house 32 which causes the spindle assembly 40 (e.g., the spindle and spindle housing) to move orbitally as the arm moves orbitally. The saw 30 may be configured to rotate the spindle 44 so as to rotate the saw blade 38 releasably attached at an end of the spindle with the tool holder 46 within the interior of the saw house. The HMI 56 may also allow the operator to disable the saw from cutting a log as desired including disabling the saw from cutting to perform a tool change as will be described in greater detail below. The tool change may be manually controlled by an operator at the HMI, or may be automatic, for instance, based upon saw blade wear or cycle time, or may be a combination of both depending upon the level of intervention desired. The tool change itself may also be performed manually without any hindrance from the automatic tool change system using the same procedures as in a saw without an automatic tool change system, for example if an appropriate blade is not available in storage unit 50, or if the automatic tool change system is not operational.

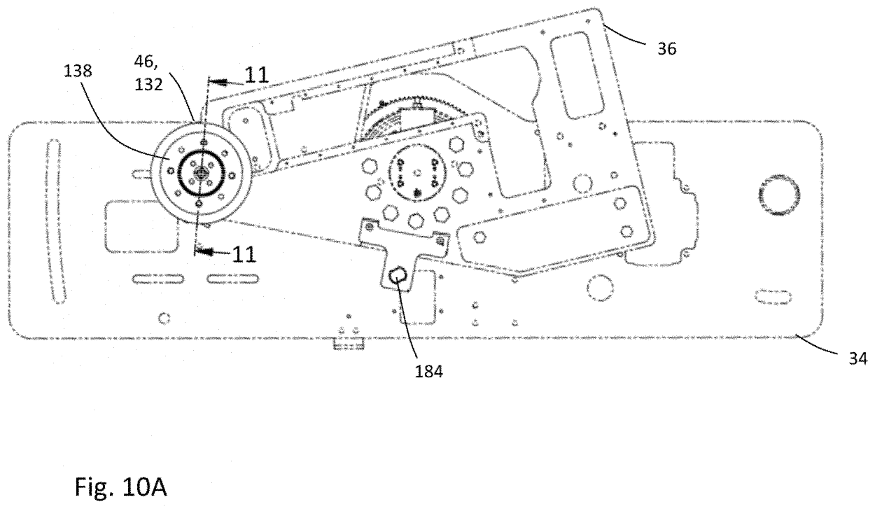

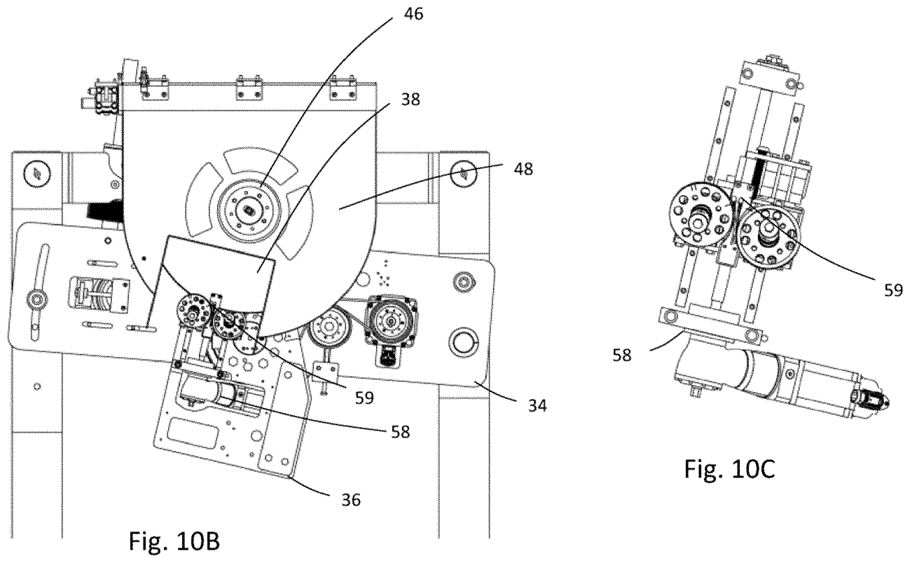

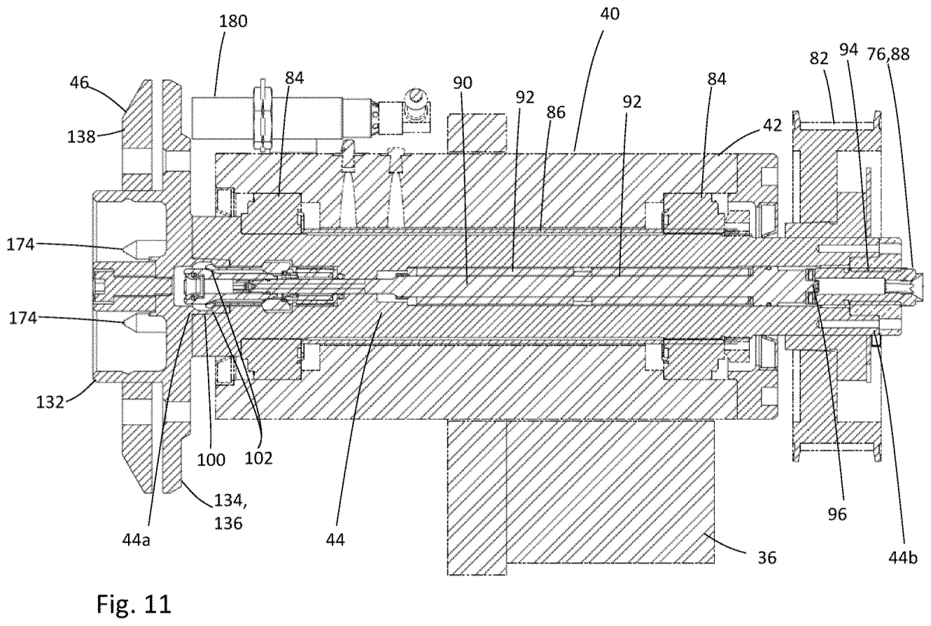

To periodically change the saw blade 38, the saw 30 may be disabled from cutting operations, a blade grinding unit 58, for instance, as shown in FIGS. 10B and 10C, may be automatically moved to a retracted position, the saw blade may be removed from the spindle 44 and exchanged with a saw blade provided in the storage unit 50, and the blade grinding unit 58 may be automatically moved to an engaged position based on the location of the edge of the newly mounted blade detected by a blade edge detector 59. The saw 30 may be provided with a tool change actuator 60 adapted and configured to work with the spindle 44 to facilitate exchange of the saw blade between the spindle and the storage unit 50. The tool change actuator 60 may be positioned in the saw house interior 34c. The tool change actuator 60 may be mounted to a structure 34 within the interior of the saw house that is separate and apart from the arm 36. In one example, the tool change actuator 60 may be mounted to a stationary structure 34 within the saw house that is sufficiently spaced from the arm 36, the spindle assembly 40 and the saw blade 38 so as to allow the arm and spindle assembly to rotate orbitally and cut a log during cutting operations as needed. In one example, the tool change actuator 60 is positioned on an upstream side (e.g., relative to the direction of log advancement) of the spindle assembly 40 and spaced from the saw blade 38. As shown in the drawings, the tool change actuator is arranged generally at the driven end 44b of the spindle 44, that is, the saw blade 38 is engaged with the spindle 44 at an end 44a opposite of the driven end. In a configuration of multiple spindle assemblies on an arm, there may be one tool change actuator arranged to work with each of the spindles to facilitate tool change between the spindle and the storage unit. Alternatively, there may be multiple tool change actuators positioned within the interior of the saw house to work with one or more spindles to facilitate tool change between the spindle and the storage unit. The tool change actuator 60 may include a servomotor 62 that drives a gearbox 64. The gearbox 64 may be operatively connected to a shaft 66, and the output shaft may be operatively connected to an end effector 68. The servomotor 62 may operatively rotate the end effector 68 at the distal end of the tool change actuator via the gear box 64 and the shaft 66. The shaft 66 may be operatively connected to the end effector 68 with a flex coupling 70. The servomotor 62 and gearbox 64 may be mounted to a subplate 72. The servomotor 62, the gearbox 64, the shaft 66, and the end effector 68 may move relative to the subplate 72 via a linear actuator 74. In another embodiment, the motions of the servo motor 62 and linear actuator 74 may be provided by a linear rotary servo motor. The shaft 66 may extend through a hole in the subplate 72 so that the end effector 68 is on one side of the subplate and the servomotor 62 and the gear box 64 are on the opposite side of the subplate. The linear actuator 74 may allow the servomotor 62 and the gear box 64 to reciprocate in a linear fashion relative to the driven end 44b of the spindle. For instance, the linear actuator 74 may be a pneumatic cylinder, and two linear actuators may be placed on opposite sides of the servomotor and gear box. Through the linear actuator 74, the tool change actuator 60 may be enabled to position the end effector 68 in (i) a retracted position where the end effector is spaced from the driven end 44b of the spindle, (ii) an engagement position where the end effector 68 is in initial engagement with a tool holder clamp 76 of the spindle, and (iii) an actuation position where the end effector 68 is in full engagement with the tool holder clamp 76 of the spindle. In one aspect, when the tool change actuator 60 moves the end effector 68 to the retracted position, the end effector is at a first distance from the subplate 72 and spaced from the driven end 44b of the spindle; when the tool change actuator 60 moves the end effector 68 to the engagement position, the end effector moves away from the subplate 72 to a second distance which is greater than the first distance, and engages the tool holder clamp 76 of the spindle 44, and when the tool change actuator 60 moves the end effector 68 to the actuation position, the end effector moves away from the subplate 72 to a third distance which is greater than the second distance while maintaining engagement with the tool holder clamp 76 of the spindle 44.

The tool change actuator 60 may include an end effector drive sensor 78. The end effect drive sensor 78 may be adapted and configured to sense when the end effector 68 has moved between the retracted position and the engagement position. The end effector drive sensor 78 may be a position transmitter disposed adjacent the linear actuator 74 so as to measure the displacement of the end effector 68 via the movement of the linear actuator 74. Feedback from the servomotor 68 and signals from the end effector drive sensor 78 may be used to provide an indication of movement of the end effector between the engagement position and the actuation position, as will be discussed below.

The spindle assembly 40 may include the spindle 44 rotatably disposed in the spindle housing 42. As stated before, the spindle housing 44 is mounted to the arm 36 so the spindle assembly moves with the arm. The spindle 44 has a driven end 44b for rotating the spindle. For instance, a spindle drive chain 80 may rotate the spindle 44 via a toothed belt (not shown) and toothed gear 82 provided at the driven end 44B of the spindle. The spindle 44 may be supported in the spindle housing 42 with bearings 84 and a sleeve assembly 86. The spindle 44 may have the tool holder clamp 76 disposed in the center of the spindle extending along a center axis of rotation of the spindle. The tool holder clamp 76 may releasably engage the tool holder 46 of the saw blade 38 at the end 44a of the spindle, which is opposite the driven end 44b of the spindle. The tool holder clamp 76 may have an operator 88 that is accessible at the driven end 44b of the spindle.

The operator 88 may be configured to allow movement of the clamp 76 between a hold position in which the clamp 76 secures the tool holder 46 to the first end 44a of the spindle and a release position in which the clamp 76 moves to a position relative to the spindle 44 to allow the tool holder 46 to be removed from the first end 44a of the spindle. The clamp 76 may include a drawbar 90 that extends through the spindle center and allows operation of the clamp at the first end 44a of the spindle with the operator 88 at the driven end 44b of the spindle. The drawbar 90 may act against spring pressure when the clamp 76 is moved from the hold position to the release position. One or more springs or a spring stack 92 acting on the drawbar may urge the clamp to the hold position. The driven end 44b of the spindle may be configured with a threaded region 94, and the operator 88 may be provided as a screw threaded member. For instance, the operator 88 may be an Acme threaded screw member that engages the threaded region 94 of the spindle. Thus, in moving the clamp 76 from the hold position to the release position, the threaded screw member of the operator 88 may be rotated within the threaded region 94 of the spindle so the threaded screw member of the operator 88 rotates and moves linearly along the center axis of the spindle. A thrust bearing 96 may be disposed between the threaded member of the operator 88 and the drawbar 90 so as to allow the operator to engage the drawbar and move the drawbar against spring pressure as the operator rotates and moves linearly to move the clamp from the hold position to the release position. The threaded region 94 of the spindle may be provided via a locking nut that is secured at the axial end of the driven end of the spindle. The locking nut may receive the threaded member of the operator 88.

The operator 88 may include a releasable drive connection that cooperates with the end effector 68, so as the end effector 68 rotates, the operator 88 may rotate and thread through the threaded region 94 of the spindle to move the drawbar 90 as needed. In one aspect, the end effector 68 and the operator 88 have a hexalobe type configuration. To allow for slight misalignment between the end effector 68 and the operator 88, the flexible coupling 70 may be provided on the shaft connection to end effector. The end effector drive sensor 78 may be configured to sense when the end effector 68 abuts the operator 88 and when the end effector is fully engaged with the operator, and based on the end effector drive sensor signals, the linear actuator 74 and servomotor 62 of the tool change actuator may be operated in a manner to rotate the end effector 68 and axially displace the end effector from a position in which the end effector abuts the operator and then moves to the engagement position. In one aspect, the tool change actuator 60 may rotate the end effector 68 incrementally while pressing the end effector against the operator 88 under light pressure from the linear actuator 74 until the end effector 68 moves axially and fully engages the operator 88 of the tool holder clamp 76. To prevent rotation of the spindle 44 while the end effector 68 rotates and axially displaces the operator/threaded member 88, the toothed belt acting on the toothed drive pulley 82 on the driven end 44b of the spindle, and the spindle drive 80 holding position for the spindle servomotor provide sufficient inertia and counter torque against the rotation of the spindle.

The first end 44a of the spindle may be configured in a manner to receive the tool holder 46 of the saw blade. For instance, in one configuration, the first end 44a of the spindle includes a tapered bore 100 which receives the tool holder 46. The clamp 76 extends into the tapered bore and has fingers 102 that are adapted and configured to engage the tool holder 46. In one aspect, the fingers 102 of the clamp 76 may cooperate with the tool holder 46 to hold the tool holder in the tapered bore 100 of the spindle when the clamp is in the hold position thereby securing the tool holder with the spindle 44 as an integral unit allowing the spindle to rotate the saw blade 38 mounted to the tool holder 46 to cut a log. When the clamp 76 is moved to the release position, the fingers 102 of the clamp may cooperate with the tool holder 46 to disengage the tool holder from the tapered bore 100 on the spindle to allow the saw blade and the tool holder to be removed from the spindle.

The exemplary blade array 52 comprises a frame with a plurality of drawers or storage units 50 that are each adapted and configured to move from a retracted position in which the storage unit is contained within the blade array and an extended position in which the storage unit moves in a linear fashion outward from the blade array into the interior of the saw house. The blade array frame may include telescoping rails and guides 101 for each storage unit that allow the storage unit to move linearly between the retracted and extended positions. Each storage unit may have a tab 102 extending from the frame. The tab 102 may cooperate with a pull bar 104 (FIG. 1) of the saw so when the blade array 52 is connected with the saw 30, the pull bar 104 may engage the tab 102 of the respective storage unit 50 and move the storage unit from the retracted position in the blade array to the interior of the saw house adjacent the first end of the spindle, and vice versa. As described previously, the blade array 52 may be mounted on a slide 54 extending from the structure 34 of the saw house 32. The slide 54 may move the blade array in the direction of advancement of the logs, so the saw 30 may move a respective storage unit 50 adjacent the spindle 44. Preferably, the saw 30 is provided with one pull bar 104, and the motion of the slide 54 is configured to move the tab 102 of the respective storage unit 50 into register with the pull bar 104 when a specific storage unit is called for by the control of the saw 30.

The blade array 52 may be detachably connected with the structure 34 of the saw house 30, for instance, detachably connected with the slide 54 of the saw house. One blade array may be serviced off line, for instance, to replace worn blades, and another blade array may be moved into position and connected with the saw house. The blade array may include casters 106 that allow the blade array to be moved as desired in the facility and adjacent to the saw, and to allow one blade array to be changed with another blade array to facilitate saw operations. The blade array frame may also include fork tubes 108 that enable the blade array to be moved with a forklift and/or strap openings 110 for connection with lifting straps and a crane or other overhead lifting devices. The blade array frame may also be provided with hand grips 111 to enable the blade array to be moved manually as desired. The blade array may also be provided with releasable connections 112 to enable the blade array frame to be detachably mounted on the slide(s) 54,55 of the saw house 32.

At the center of each storage unit or drawer of the blade array, the storage unit may be provided with a hub structure 120 that allows the tool holder with the saw blade to releasably engaged with the storage unit. The storage unit hub structure 120 has features allowing the tool holder 46 with the saw blade 38 to be removed from the storage unit with the clamp 76 of the spindle 44 and allowing the clamp of the spindle to mount the tool holder with the saw blade on the hub structure in the storage unit. When the storage unit 50 is moved to the extended position, the storage unit may be positioned sufficiently adjacent the first end 44a of the spindle so as to allow the clamp 76 to engage the tool holder and move the tool holder 46 and the saw blade 38 from the hub structure 120 of the storage unit to the first end of the spindle, and to move the tool holder with the saw blade from the spindle to the hub structure of the storage unit.

The tool holder 46 may have a first side 132 and a second side 134. The first side 132 of the tool holder 46 may be adapted and configured to releasably engage the hub structure 120 of the storage unit 50. The second side 134 of the tool holder 46 may be adapted and configured to releasably engage the clamp 76 at the first end 44a of the spindle. In one aspect, the tool holder may be formed as a two piece assembly with a blade holder 136 supporting the saw blade 38 and a blade clamp 138 that secures the saw blade to the blade holder. The blade holder 136 may be adapted and configured to releasably connect with the first end 44a of the spindle and also releasably connect with the hub structure 120 of the storage unit 50. The blade clamp 138 may be secured to the blade holder 138 with mechanical fasteners 140 that pass through the blade clamp, matching holes in the saw blade, and secured in place in threaded holes 142 in the blade holder 136.

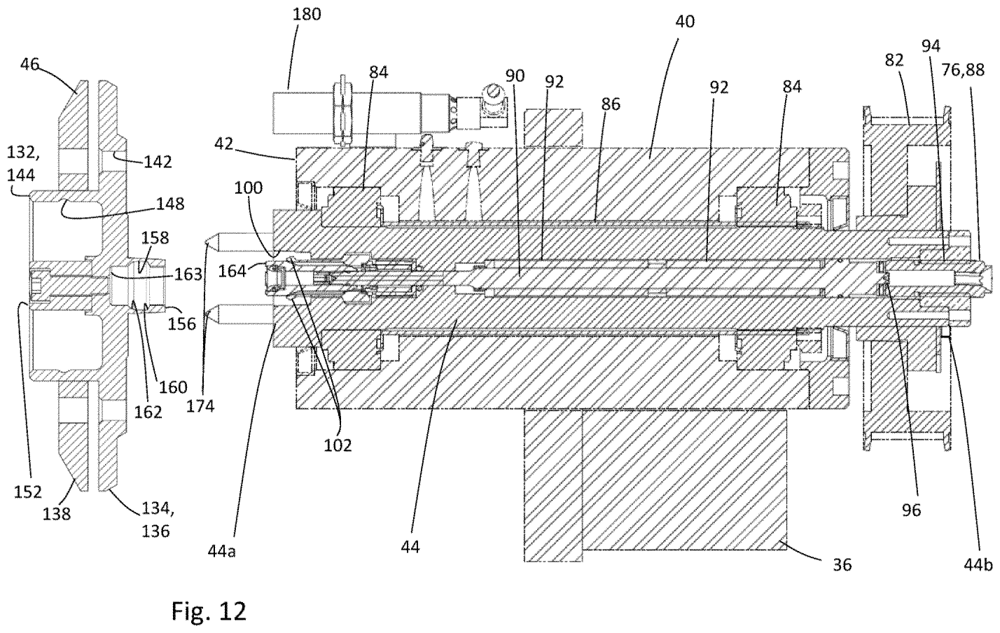

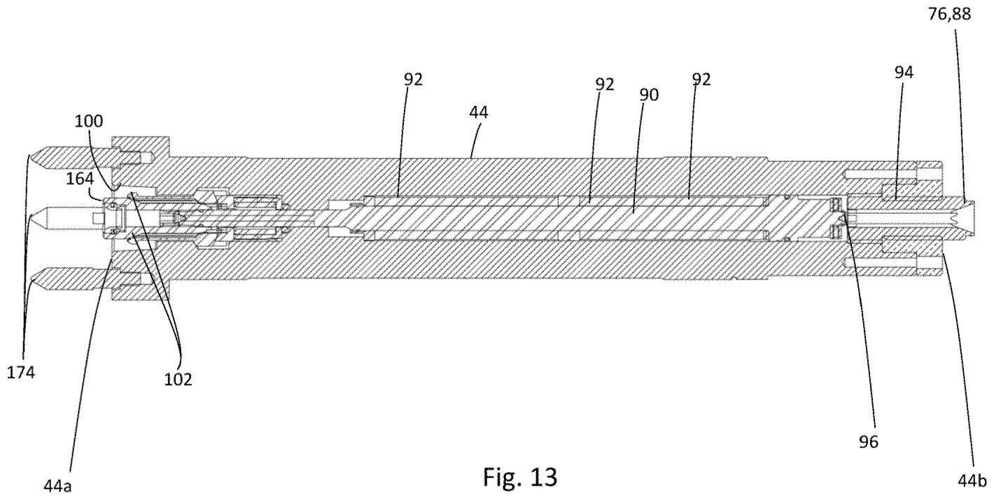

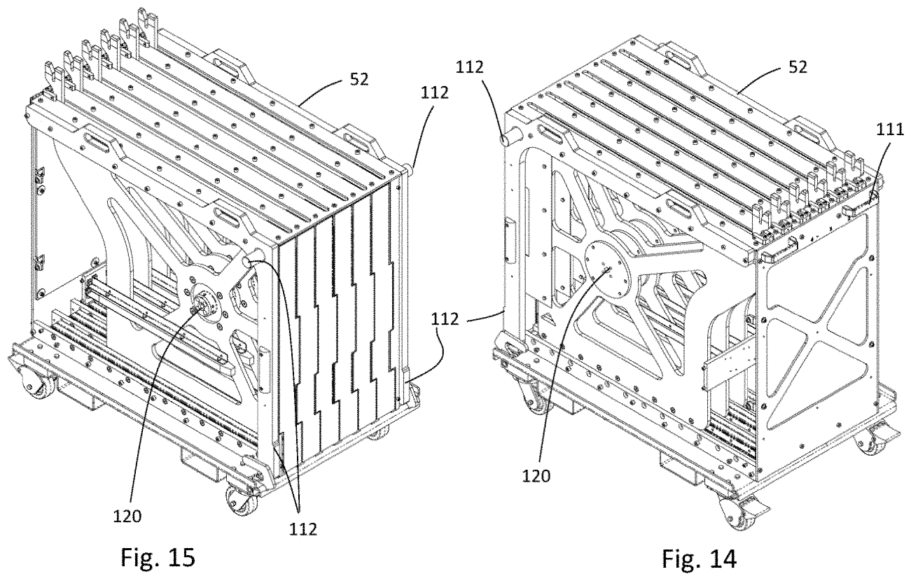

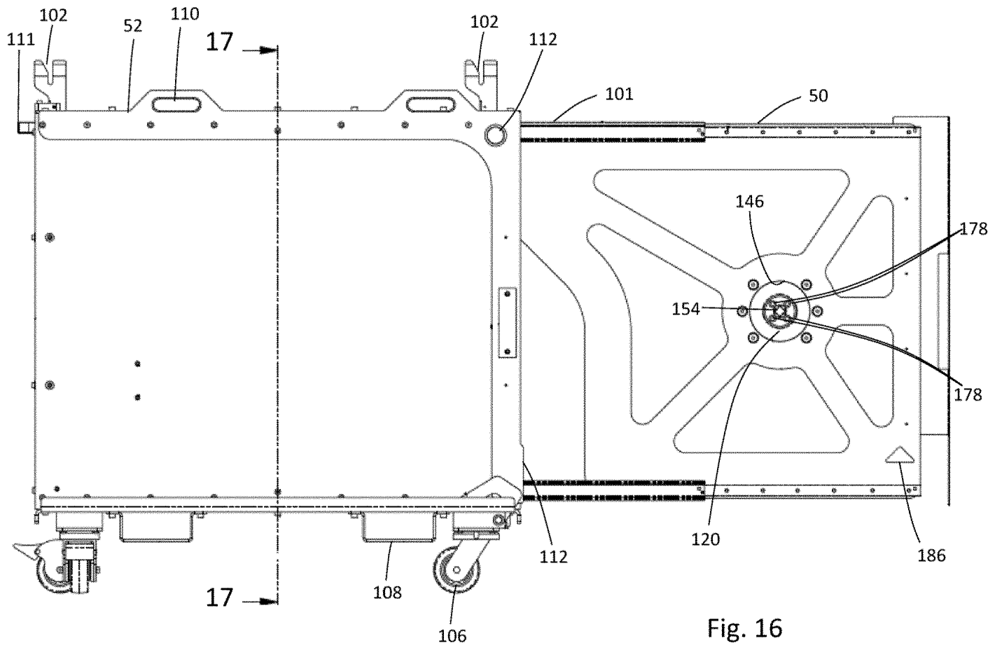

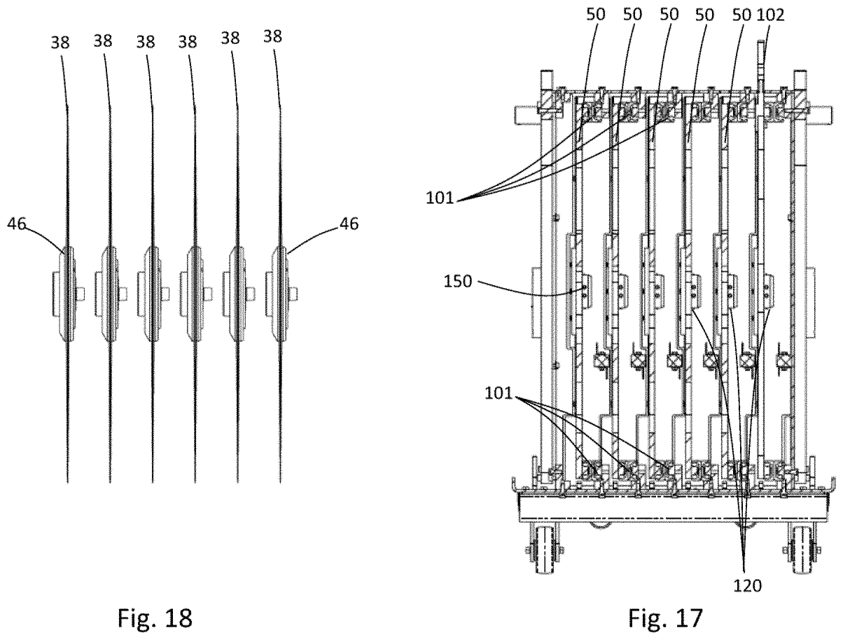

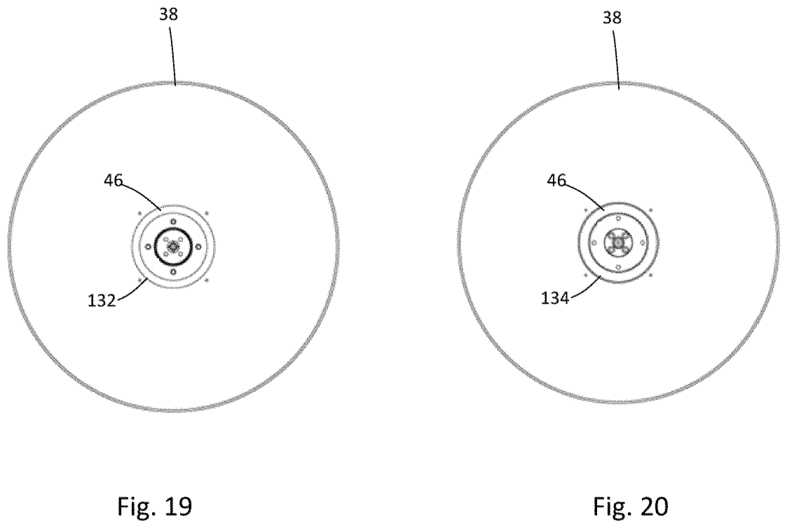

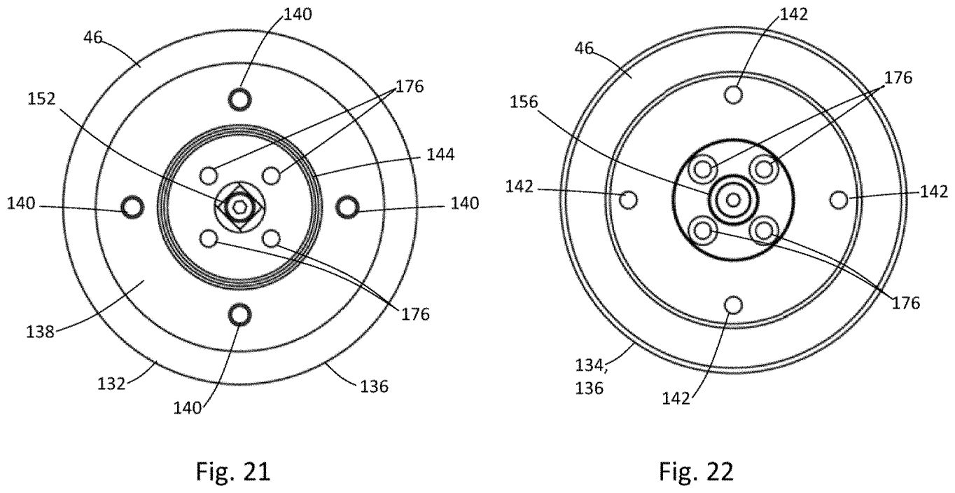

In one aspect, the blade holder 136 may have features that form first and second sides 132,134 of the tool holder. For instance, the blade holder 136 may have an annular wall 144 that extends from one side of the tool holder. The annular wall 144 may have an outer diameter surface that provides a locator for the blade clamp. The outer diameter surface of the annular wall 144 may also fit within a recess 146 (FIG. 16) of the hub structure 120 on the storage unit to allow the recess support a portion of the tool holder 46 and saw blade 38 within the storage unit 50. The annular wall may also have an inner diameter surface. The inner diameter surface may have a groove 148 (FIG. 12), which may be a discontinuous groove, that may be adapted to receive a spring loaded pawl 150 (FIG. 17) on the hub structure 120. For instance, the hub structure 120 of the storage unit 50 may be provided with four spring loaded pawls 150 that engage the groove 148 on the inner diameter surface of the annular wall 144. In the alternative, the hub structure may be provided with canted coil springs, a pneumatic spring/bladder, elastomeric springs or elastomer material to engage the groove 148 on the inner diameter of the annular wall. The tool holder 46 may also have a center locator hub 152 that extends from the tool holder. The center locator hub 152 may be connected to the blade holder 136. The center locator hub 152 may fit within a hole 154 (FIG. 16) of the hub structure to further support and align the tool holder 46 in the storage unit 50, as will be described in greater detail below.

The blade holder 136 may also be formed with features that form the second side 134 of the tool holder 46. For instance, the blade holder 136 may be formed with an annular extension 156. The annular extension 156 may have an outer diameter surface which is tapered and cooperates with the tapered bore 100 at the first end 44a of the spindle. The annular extension 156 may also include a bore with a center axis that is aligned with the tapered outer surface of the annular extension. The bore may be defined by an interior surface. The interior surface may include an enlarged interior radius area 158 so that the interior surface has two regions 160,162 that cooperate with the fingers 102 of the clamp 76. The first region 160 of the interior surface 158 may be shaped in a manner so that the fingers 102 of the clamp 76 engage the first region 160 of the interior surface 158 when the clamp 76 moves from the release position to the hold position. The interior surface 158 may also have a second region 162 that is adapted and configured to be engaged by the fingers 102 of the clamp 76 when the clamp moves from the hold position to the release position. The second region 162 of the interior surface 158 of the bore may also be configured and shaped with a shoulder 163 to receive a plunger 164 of the clamp 76. The plunger 164 of the clamp 74 may bear against the shoulder 163 of the second region 162 of the interior surface 158 of the bore to facilitate removing the tool holder 46 from the first end 44a of the spindle.

To ensure alignment of the end effector 68 with the operator 88 of the clamp 76 of the spindle 44, the tool change actuator 60 may be configured to slowly rotate the end effector 68 until the end effector fully engages the operator with a correct alignment. The end effector drive sensor 78 may be provided on the linear actuator 74 of the tool change actuator 60 to sense when the end effector 68 moves sufficiently in the direction of the center axis of the spindle 44 to properly engage the operator 88. The end effector drive sensor 78 is configured and adapted to sense when the end effector 68 has moved from the retracted position to the engagement position relative to the operator 88 and the driven end 44b of the spindle. In moving the end effector 68 from the engagement position to the actuation position, the servomotor 62 of the tool change actuator 60 rotates the end effector 68 while the linear actuator 74 moves the tool change actuator 60 and thus end effector 68 axially thereby threadably engaging the operator 88 with the threaded region 94 of the spindle 44 to drive the operator 88 along the center axis of the spindle. The pitch of the screw threading and the rotation of the tool change actuator servomotor 62 for each tool change cycle may be stored in a memory of the control and used to determine the distance that the clamp 76 has moved from the hold position to the release position as the tool change actuator 60 moves the end effector 68 from the engagement position to the actuation position, and from the release position to the hold position as the tool change actuator moves the end effector from the actuation position to the engagement position. The rotation of the tool change actuator servomotor 62 for each tool change cycle may be stored in a memory of the control and used to determine the angular relation of the end effector 68 to the operator 88, and the angular relation of the spindle 44 to the tool holder 46.

To further facilitate alignment between the end effector 68 and the operator 88 and to facilitate alignment of the tool holder 46 with the spindle 44, the driven end 44b of the spindle may be provided with a flag 170 and the tool change actuator 60 may be provided with a proximity sensor 172. The flag 170 and the proximity sensor 172 may work together as a spindle rotation sensor that is adapted and configured to determine the angular position of the spindle 44. The spindle rotation sensor 170,172 may generate a signal to the control to rotate the spindle drive servomotor as needed to provide any necessary alignment. The first end 44a of the spindle may be provided with plurality of guide pins 174 projecting outward from the first end of the spindle. The guide pins 174 may cooperate with guide holes 176 formed in the tool holder 46 and guide holes 178 formed in the hub structure 120 of the storage unit 50. The guide pins 174 aid in aligning the tool holder 46 on the spindle 44 when the saw blade 38 with the tool holder is moved from the storage unit 50 to the spindle, and to ensure the tool holder 46 is properly oriented on the hub structure 120 when the saw blade 38 with the tool holder 46 is moved from the spindle 44 to the storage unit 50. The spindle rotation sensor 170,172 may send a signal to the control to the spindle drive servomotor to rotate the spindle 44 as necessary to provide the alignment so the guide pins 174 come into register with the guide holes 176 formed in the tool holder 46 and the guide holes 178 formed in the hub structure 120 of the storage unit 50. Further, to aid in alignment of the tool holder 46 and the saw blade 38 on the spindle 44, a tool holder engagement sensor 180 may be provided on the spindle housing 42. The tool holder engagement sensor 180 may be a proximity sensor that is adapted and configured to determine the distance between the tool holder 46 and the spindle 44, for instance, the rear axial face of the blade holder 136 and the spindle 44. In operation, after the saw blade 38 with the tool holder 46 is moved from the storage unit 50 to the spindle 44, the spindle may be slowly rotated prior to commencing of the cutting of the log to sense any distance variation between the tool holder 46 and the tool holder engagement sensor 180 around the tool holder. To the extent the tool holder engagement sensor 180 senses any excessive variation of the distance between the tool holder 46 and the proximity sensor 180, for instance, circular run-out of the tool holder, the control of the saw 30 can provide an alert or alarm if the variation is excessive, and/or adjust the pressure of the clamp 76 to reseat the tool holder 46 in the spindle 44.

To provide further alignment between the storage unit 50 and the spindle 44 during a tool change, the arm 36 may be provided with a storage unit alignment sensor 184. The storage unit alignment sensor 184 may be adapted to sense the position of the storage unit 50 relative to the spindle 44 when the storage unit is in the extended position in the interior of the saw house 32 adjacent the first end 44a of the spindle. The storage unit 50 may be provided with a triangular cut out 186 at a distal end of the storage unit. The triangular cut out 186 may cooperate with the storage unit alignment sensor 184 to enable the storage unit alignment sensor to sense the position of the storage unit, and in particular, in a plane which is arranged perpendicular to the center axis of the spindle. The triangular cut-out 186 provides a graduated indication with an apex or maximum spacing that can be sensed by the storage unit alignment sensor 184 to enable the control to determine the position of the storage unit 50 in the extended position. The storage unit alignment sensor may provide signals to the control that enable the pull bar 104 on the saw house 32 to be operated as necessary to provide alignment of the storage unit 50 in the cross machine direction. The storage unit alignment sensor 184 may also provide signals to the control enabling the control to provide signals to the vertical slide 55 to adjust the height of the array 52 and/or storage unit 50. The desired storage unit alignment position may be associated with a position in which the storage unit alignment sensor 184 is located with a known relationship relative to the center of the blade spindle 44. The geometric center of the triangular cut out 186 in the storage unit may also have a known relationship with the center of the hub for the tool holder in the blade storage unit 120. With these relationships known, an alignment correction can be derived by evaluating the fraction of the motion of the blade storage unit extension that the alignment sensor 184 is influenced by the triangular cut out 186 and relating it to what is expected given ideal alignment. For example, consider 186 to be an isosceles triangular cut out with angles of 45°,45°, and 90° and an arbitrary cartesian coordinate system with the origin defined to be at the axis of rotation of the blade spindle 44 and coplanar with the blade 38. During extension of the blade storage unit 50 towards the blade spindle, the position is decreasing as the blade storage unit 50 approaches the blade spindle 44. The triangle 186 will pass the storage unit alignment sensor 184 during this motion. The extension positions of the blade storage unit associated with the leading and trailing edges of the triangular cut out will be captured as X_Leading, and X_Trailing respectively. Given this information, the detected position of the triangle position can be evaluated in relation to the desired position. To continue, consider the point (X_Target,Y_Target) to be the geometric center of the triangle that would correspond to the blade storage unit positioned ideally relative to the measurement sensor and blade spindle. TargetWidth is the width of the triangle at this point.

These incremental corrections can be used to adjust the position of the blade storage unit to provide ideal alignment of the blade spindle (44) and the blade tool holder (46). Given the description, it should be obvious that the geometric shape used for this system does not have to be limited to a triangle. Any shape with an edge that is not perpendicular to the axis of motion of the blade storage unit as it enters the saw house could work. The triangle, as described, provides a simple and concise geometry that provides good resolution relative to the expected magnitude of the alignment errors in both axes and is also easily added to the described blade storage unit during manufacturing.

In the description above, the principle and embodiments of the present application are illustrated herein by specific examples. The description of the above embodiments is only intended to facilitate the understanding of the method and the concept of the present application. For those skilled in the art, changes can be made to specific embodiments and an application scope of the present application, according to the concepts of the application. In conclusion, contents of the specification should not be construed as limitation to the present application.

What is claimed is:

1. A tissue log cutting saw, wherein the saw is adapted and configured to be enabled for cutting a tissue log axially into rolls and disabled from cutting the tissue log into rolls, the tissue log cutting saw comprising:
a saw house with an interior;
an arm adapted and configured to move orbitally within the interior of saw house;
a spindle rotatably mounted in a spindle housing, the spindle housing mounted to the arm, the spindle having a first end and an opposite second end, the spindle having a clamp, the clamp being adapted and configured to engage a tool holder at the first end of the spindle, the second end of the spindle being adapted and configured to rotationally drive the spindle, the clamp having an operator, the operator of the clamp being accessible at the second end of the spindle, the clamp being moveable with the operator relative to the spindle between a hold position and a release position, wherein in the hold position, the clamp is adapted and configured to engage the tool holder at the first end of the spindle, wherein in the release position, the clamp is adapted and configured to disengage from the tool holder and allow the tool holder to be removed from the first end of the spindle;
an actuator within the saw house interior, the actuator being mounted to a structure separate from the arm, the actuator having an end effector on a distal end of the actuator, the actuator being adapted and configured to rotate the end effector and axially displace the end effector while rotating the end effector, the actuator being adapted and configured to move the end effector to a retracted position, an engagement position and an actuation position;
wherein when the saw is enabled for cutting the tissue log, the saw is adapted and configured to: (i) move the arm orbitally; (ii) move the spindle orbitally as the arm moves orbitally; and (iii) rotate the spindle;
wherein when the saw is disabled from cutting the tissue log, the saw is adapted and configured to move the arm and the spindle to a tool change position, and with the arm and the spindle in the tool change position, the saw is adapted and configured to: (a) align the second end of the spindle with the end effector of the actuator; (b) enable the actuator to rotate and axially displace the end effector from the retracted position to the engagement position to the actuation position; and (c) enable the actuator to rotate and axially displace the end effector from the actuation position to the engagement position to the retracted position, wherein in the retracted position, the end effector is spaced from the operator, wherein in the engagement position the end effector is in engagement with the operator with the clamp in the hold position, and wherein in the actuation position, the end effector is in engagement with the operator with the clamp in the release position.

2. The saw of claim 1, wherein the clamp includes a drawbar, the drawbar extends through the spindle and is operatively connected to the operator, the drawbar is movable with the operator in moving the clamp between the release position and the hold position.

3. The saw of claim 2 wherein the drawbar is urged to the hold position with a spring.

4. The saw of claim 2 wherein the operator includes a threaded member, the threaded member is threadably engaged with the spindle, the threaded member is operatively connected with the drawbar and is movable with the drawbar in moving the clamp between the release position and the hold position.

5. The saw of claim 4 wherein the threaded member is accessible at the second end of the spindle.

6. The saw of claim 4 wherein the threaded member has a drive surface that cooperates with the end effector.

7. The saw of claim 6 wherein the threaded member is adapted and configured to rotate and axially move in a bore of the spindle when the actuator axially displaces and rotates the end effector between the engagement position and the actuation position.

8. The saw of claim 1 wherein the first end of the spindle has a tapered bore configured to receive the tool holder when the clamp engages the tool holder in the hold position.

9. The saw of claim 1 wherein the first end of the spindle has at least one guide pin that cooperates with a hole in the tool holder and aligns the tool holder with the first end of the spindle.

10. The saw of claim 1 further comprising a tool holder engagement sensor mounted on the spindle housing, the tool holder engagement sensor being adapted and configured to sense a distance between a surface of the tool holder and the spindle.

11. The saw of claim 1 further comprising an end effector drive sensor, the end effector drive sensor being adapted and configured to sense when the end effector has moved between the retracted position and the engagement position.

12. The saw of claim 1 further comprising an end effector actuation sensor, the end effector actuation sensor being adapted and configured to sense when the end effector has moved between the engagement position and the actuation position.

13. The saw of claim 12 wherein the end effector actuation sensor is adapted and configured to sense rotation of the end effector.

14. The saw of claim 1 wherein the end effector is operatively connected with the actuator with a flex coupling.

15. The saw of claim 1 further comprising a spindle rotation sensor, the spindle rotation sensor being adapted and configured to sense an angular position of the spindle when the spindle is in the tool change position.

16. The saw of claim 1 further comprising a blade storage array, the blade storage array comprising a plurality of storage units, each storage unit being configured to store a saw blade for the saw, each storage unit being configured to move into and out of the interior of the saw house;
wherein when the arm and the spindle are in the tool change position, the saw is adapted and configured to: (d) exchange the saw blade between the spindle and the storage unit.

17. The saw of claim 16 further comprising a storage unit alignment sensor mounted on the arm, the storage unit alignment sensor being adapted and configured to sense a position of the storage unit relative to the spindle.

18. The saw of claim 17 wherein the storage unit alignment sensor is configured to sense the position on the storage unit relative to the spindle in a plane arranged perpendicular to a center axis of the spindle.

19. The saw of claim 17 wherein the blade storage array is adapted and configured to detachably mount to a structure of the saw house.

20. The saw of claim 1 further comprising a tool holder, wherein the tool holder is adapted and configured to hold a saw blade, the tool holder is adapted to be releasably attached at the first end of the spindle with the clamp in the hold position.

21. A tissue log cutting saw, wherein the saw is adapted and configured to be enabled for cutting a tissue log axially into rolls and disabled from cutting the tissue log into rolls, the tissue log cutting saw comprising:
a saw house with an interior;
a storage unit configured to store a circular saw blade for the saw, the storage unit being configured to move into and out of the interior of the saw house between an extended position and a retracted position;
an arm adapted and configured to move orbitally within the interior of saw house;
a spindle rotatably mounted in a spindle housing, the spindle housing mounted to the arm, the spindle having a first end and an opposite second end, the spindle having a clamp, the clamp being adapted and configured to engage a tool holder at the first end of the spindle, the second end of the spindle being adapted and configured to rotationally drive the spindle, the clamp having an operator, the operator of the clamp being accessible at the second end of the spindle, the clamp being moveable with the operator relative to the spindle between a hold position and a release position, wherein in the hold position, the clamp is adapted and configured to engage the tool holder at the first end of the spindle, wherein in the release position, the clamp is adapted and configured to disengage from the tool holder and allow the tool holder to be removed from the first end of the spindle;
an actuator within the saw house interior, the actuator being mounted to a structure separate from the arm, the actuator having an end effector on a distal end of the actuator, the actuator being adapted and configured to rotate the end effector and axially displace the end effector while rotating the end effector, the actuator being adapted and configured to move the end effector to a retracted position, an engagement position and an actuation position;
wherein when the saw is enabled for cutting the tissue log, the saw is adapted and configured to: (i) move the arm orbitally; (ii) move the spindle orbitally as the arm moves orbitally; and (iii) rotate the spindle;
wherein when the saw is disabled from cutting the tissue log, the saw is adapted and configured to move the arm and the spindle to a tool change position, and with the arm and the spindle in the tool change position, the saw is adapted and configured to: (a) align the second end of the spindle with the end effector of the actuator; (b) enable the actuator to rotate and axially displace the end effector from the retracted position to the engagement position to the actuation position; (c) enable the actuator to rotate and axially displace the end effector from the actuation position to the engagement position to the retracted position, wherein in the retracted position, the end effector is spaced from the operator, wherein in the engagement position the end effector is in engagement with the operator with the clamp in the hold position, and wherein in the actuation position, the end effector is in engagement with the operator with the clamp in the release position; and (d) exchange the saw blade between the spindle and the storage unit.

22. The saw of claim 21 further comprising a saw blade mounted on the tool holder.

23. The saw of claim 22 further comprising the saw blade mounted on the tool holder within the storage unit; and
wherein with the saw disabled from cutting the tissue log, the arm and the spindle in the tool change position, and the spindle first end devoid of a tool holder and a saw blade, the saw is adapted and configured to transfer the saw blade from the storage unit to the first end of the spindle as the actuator moves the end effector from the actuation position to the engagement position and the clamp moves from the release position to the hold position while engaging the tool holder.

24. The saw of claim 22 further comprising the saw blade mounted on the tool holder at the first end of the spindle; and
wherein with the saw disabled from cutting the tissue log, the arm and the spindle in the tool change position, and the storage unit devoid of a tool holder and a saw blade, the saw is adapted and configured to transfer the saw blade from the first end of the spindle to the storage unit as the actuator moves the end effector from the engagement position to the actuation position and the clamp moves from the hold position to the release position while engaging the tool holder.

25. The saw of claim 22 wherein the tool holder comprises and blade holder and a blade clamp, the blade holder supports the blade, and the blade clamp secures the saw blade to the blade holder.

26. The saw of claim 21 wherein:
the storage unit is one of a plurality of like storage units, each storage unit being configured to store a saw blade for the saw, each storage unit being configured to move into and out of the interior of the saw house; and
when the arm and the spindle are in the tool change position, the saw is adapted and configured to exchange the saw blade between the spindle and one of the plurality of storage units.

27. The saw of claim 26 wherein the plurality of storage blades comprises a storage array, the storage array is adapted and configured to detachably mount to a structure of the saw house.

28. The saw of claim 21 wherein the tool holder has a first side and a second side, the first side of the tool holder is adapted and configured to be releasably connected to the storage unit, the second side of the tool holder is adapted and configured to be engaged with the clamp at the first end of the spindle.

29. The saw of claim 21 wherein the tool holder first side has an annular wall with an outer diameter surface and an inner diameter surface, the inner diameter surface is adapted and configured to be releasably attached to a spring loaded hub on the storage unit, the outer diameter surface is adapted and configured to be received in a recess of the storage unit.

30. The saw of claim 29 wherein the tool holder first side has a hub at a center axis of the tool holder within the annular wall, the hub cooperates with a hole in the recess of the storage unit.

31. The saw of claim 28 wherein the second side of the tool holder has an annular extension, the annular extension has a tapered outer diameter surface, the annular extension has a bore with a center axis aligned with the tapered outer diameter surface, the bore is defined by an interior surface, the tapered outer diameter surface is adapted and configured to be received in a bore at the first end of the spindle, the interior surface has a first region that is adapted and configured to be engaged by the clamp when the clamp moves from the release position to the hold position, the interior surface has a second region that is adapted and configured to be engaged by the clamp when the clamp moves from the hold position to the release position.

32. The saw of claim 31 wherein the clamp is adapted and configured such that as the clamp moves from the release position to the hold position, the clamp engages the first region of the interior surface of the annular extension of the second side of the tool holder and draws the annular extension into the tapered bore of the first end of the spindle in a manner to enable the first side of the tool holder to release from the storage unit.

33. The saw of claim 31 wherein the clamp is adapted and configured such that as the clamp moves from the hold position to the release position, the clamp engages the second region of the interior surface of the annular extension of the second side of the tool holder region and pushes the annular extension out of the tapered bore of the first end of the spindle in a manner to enable the first side of the tool holder to engage with the storage unit.
